(19) United States
(12) Patent Application Publication
(10) Pub. No.: US 2024/0158930 A1
(43) Pub. Date: May 16, 2024

(54) ELECTROCHEMICAL CELL INCLUDING PH DIFFERENTIAL

(71) Applicant: Verdagy, Inc., Moss Landing, CA (US)

(72) Inventors: John C. Goeltz, Marina, CA (US); Thomas Albrecht, Santa Clara, CA (US)

(21) Appl. No.: 18/509,223

(22) Filed: Nov. 14, 2023

Related U.S. Application Data
(60) Provisional application No. 63/383,610, filed on Nov. 14, 2022.

(51) Int. Cl. C25B 15/031; C25B 1/02; C25B 9/23; C25B 11/085

(52) U.S. Cl. CPC C25B 15/031; C25B 1/02; C25B 9/23; C25B 11/085

(57) ABSTRACT

An electrochemical cell comprises an anode, an anode electrolyte solution in contact with the anode, wherein the anode electrolyte solution has a first pH, a cathode comprising an ionomer, a cathode electrolyte solution in contact with the cathode wherein the cathode electrolyte solution has a second pH, and a separator positioned between the anode and the cathode, wherein the electrochemical cell is configured to maintain a pH differential between the first pH and the second pH.

### CROSS-REFERENCE TO RELATED APPLICATION

This application claims priority under 35 U.S.C. § 119(e) to U.S. Provisional Application Ser. No. 63/383,610, filed on Nov. 14, 2022, entitled “ELECTROCHEMICAL CELL INCLUDING PH DIFFERENTIAL,” the disclosure of which is incorporated herein by reference in its entirety.

### BACKGROUND

The production of hydrogen plays a key role because hydrogen gas (H₂) is required for many chemical processes. As of 2022, roughly 75 million tons of H₂ gas is produced annually worldwide for various uses, such as oil refining, in the production of ammonia (through the Haber process), in the production of methanol (though reduction of carbon monoxide), or as a fuel in transportation.

Historically, a large majority of H₂ (˜95% on a weight basis) was produced from fossil fuels (e.g., by steam reforming of natural gas, partial oxidation of methane, or coal gasification). Other methods of hydrogen production include biomass gasification, low- or no-carbon dioxide (CO₂) emission methane pyrolysis, and water electrolysis. Water electrolysis uses electricity to split water molecules into H₂ gas and oxygen gas (O₂). To date, electrolysis systems and methods have been more expensive than fossil-fuel based production methods. However, fossil-fuel based methods of H₂ production have generally resulted in increased CO₂ emission compared to electrolysis. Therefore, there is a need for cost-competitive and environmentally friendly water electrolysis systems and methods for H₂ gas production.

Water electrolysis to produce H₂ gas is typically performed under either acidic conditions (e.g., at a pH of 2 or less) or alkaline conditions (e.g., at a pH of 12 or more). There are many known benefits to operating in one of these conditions, including high solution conductivity and high activity for typical catalyst surfaces, such as platinum group metal or nickel based catalysts. In addition, most water electrolysis cells are operated at the same or substantially the same pH on both the anode and the cathode sides of the cell. Even when a pH differential is intentionally applied, e.g., by configuring an electrolyzer cell so that the anode and the cathode are operated at different local pHs, the pH differential will tend to equilibrate over time. It has been found, however, that maintaining a pH differential across an electrolyzer cell can be beneficial for modifying the cell voltage. For example, performing water oxidation to O₂ at the anode in a locally alkaline environment and water reduction to H₂ at the cathode in a locally acidic environment or an environment that is less alkaline than at the anode can reduce the effective nominal open circuit voltage by about 59 mV per pH unit difference at 25° C. Such operation can also improve safety and expand materials compatibility options. But, maintaining a pH differential can be inefficient and time-consuming, for example by requiring additional energy to be added to the system to maintain the pH differential.

### SUMMARY

The present disclosure describes systems and methods for water electrolysis to produce hydrogen gas (H₂), and in particular to an electrolyzer comprising one or more electrolyzer cells for the production of H₂ gas. An electrolyzer cell according to the present disclosure can provide for more efficient maintenance of a pH differential between the anode and the cathode of the electrolyzer cell.

The present disclosure describes an electrochemical cell comprising an anode, an anode electrolyte solution in contact with the anode, wherein the anode electrolyte solution has a first pH, a cathode comprising an ionomer, a cathode electrolyte solution in contact with the cathode wherein the cathode electrolyte solution has a second pH, and a separator positioned between the anode and the cathode, wherein the electrochemical cell is configured to maintain a pH differential between the first pH and the second pH.

The present disclosure also describes a method of electrolysis, the method comprising providing an electrochemical cell comprising a separator having a first side and an opposing second side, am anode positioned on the first side of the separator, and a cathode comprising an ionomer positioned on the second side of the separator, contacting the anode with an anode electrolyte solution having a first pH, contacting the cathode with a cathode electrolyte solution having a second pH, maintaining a pH differential between the first pH and the second pH, passing current between the anode and the cathode, and producing hydrogen gas (H₂) at the cathode.

### BRIEF DESCRIPTION OF THE FIGURES

The drawings illustrate generally, by way of example, but not by way of limitation, various embodiments discussed in the present document.

FIG. 1 is a schematic diagram of an example electrolyzer cell for the electrolysis of water to produce hydrogen gas.

FIG. 2 is a graph of voltage responses for one configuration of a water electrolysis system operating with no pH differential (e.g., with both the anolyte and the catholyte having a pH of 14) compared to the same system operating with the anolyte having a pH of 14 and with the catholyte having pH of 7.

FIG. 3 is a cross-sectional view of an example electrolyzer cell comprising an anode pan assembly and a cathode pan assembly, in accordance with the present disclosure.

FIG. 4 is a graph of the voltage response to various current densities of the electrolyzer cell with a cathode comprising an ionomer described in EXAMPLE 1 compared to the voltage response to various current densities of an electrolyzer cell with both electrodes not including an ionomer as described in COMPARATIVE EXAMPLE 2.

FIG. 5 is a graph of the voltage response to various current densities of an electrolyzer cell with a cathode comprising an ionomer at various electrolyte pH values as in EXAMPLES 3-5 compared to data from a prior art system of Teschke (COMPARATIVE EXAMPLE 6.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a recited range of values of “about 0.1 to about 5” should be interpreted to include not only the explicitly recited values of about 0.1 and about 5, but also all individual concentrations within the indicated range of values (e.g., 1, 1.23, 2, 2.85, 3, 3.529, and 4, to name just a few) as well as sub-ranges that fall within the recited range (e.g., about 0.1 to about 0.5, about 1.21 to about 2.36, about 3.3 to about 4.9, or about 1.2 to about 4.7, to name just a few). The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1′” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### Hydrogen Production Through Electrolysis

Hydrogen gas (H₂) can be formed electrochemically by a water-splitting reaction where water is split into H₂ gas and (optionally) oxygen gas (O₂) at a cathode and an anode of an electrochemical cell, respectively. Examples of such electrochemical processes include, without limitation, proton electrolyte membrane (PEM) electrolysis and alkaline water electrolysis (AWE). In such electrochemical reactions, the operating energy necessary to drive the water-splitting electrolysis reaction is high due to additional energy costs as a result of various energy inefficiencies. For example, to reduce unwanted migration of ionic species between the electrodes, the cathode and the anode may be separated by a separator, such as a membrane, which can reduce migration of the ionic species. Although the separator can improve the overall efficiency of the cell, it can come at a cost of additional resistive losses in the cell, which in turn increases the operating voltage. Other inefficiencies in water electrolysis can include solution resistance losses, electric conduction inefficiencies, and/or electrode over-potentials, among others.

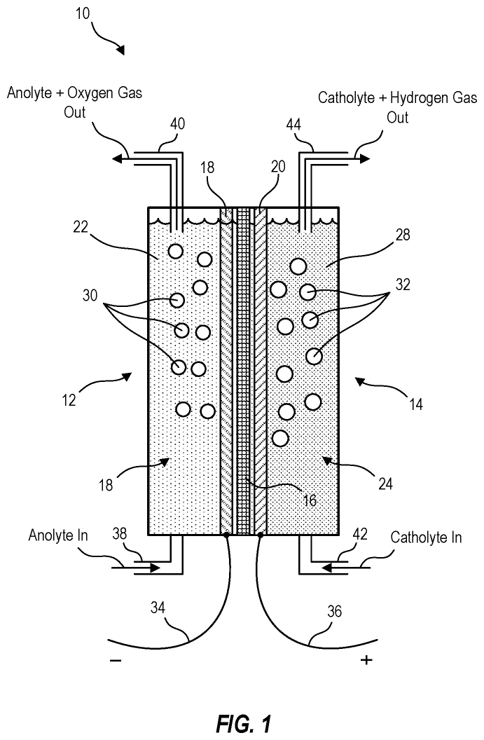

FIG. 1 is a schematic diagram of a conventional water electrolyzer cell 10 that converts water (H₂O) into hydrogen gas (H₂) and oxygen gas (O₂) with electrical power. In an example, the electrolyzer cell 10 comprises a housing 11, e.g., an overall chassis structure that defines and at least partially encloses an interior of the cell 10. The housing 11 can divide the cell 10 into two half cells: a first half cell 12 and a second half cell 14. In an example, the first and second half cells 12, 14 are separated by a separator 16, such as a membrane. In an example, the separator 16 comprises a porous membrane (e.g., a microporous membrane or a nanoporous membrane), an ion-exchange membrane, or an ion solvating membrane. In examples wherein the separator 16 comprises an ion-exchange membrane, the membrane can be of different types, such as an anion exchange membrane (AEM), a cation exchange membrane (CEM), a proton exchange membrane (PEM), or a bipolar ion exchange membrane (BEM). In some examples, depending on the need to restrict or allow migration of a specific cation or an anion species between the electrolytes, the separator 16 may be more restrictive and thus allows migration of one species of ion while restricting the migration of another species of ion. For example, if the separator 16 is a cation exchange membrane (CEM), it can be configured to allow migration of one or more specific species of cations while restricting the migration of one or more other species of cations. Similarly, if the separator 16 is an anion exchange membrane (AEM), it can be more restrictive and thus allow migration of one or more species of anions while restricting the migration of one or more other species of anions.

In some examples, the separator 16 can be selected so that it can function in an acidic and/or an alkaline electrolytic solution, as appropriate. Other properties for the separator 16 that may be desirable include, but are not limited to, high ion selectivity, low ionic resistance, high burst strength, and high stability in electrolytic solution in a temperature range of room temperature to 150° C. or higher. In an example, the separator 16 is stable in a temperature range of from about 0° C. to about 150° C., for example from about 0° C. to about 100° C., such as from about 0° C. to about 90° C., for example from about 0° C. to about 80° C., such as from about 0° C. to about 70° C., for example from about 0° C. to about 60° C., such as from about 0° C., to about 50° C., for example from about 0° C. to about 40° C., or such as from about 0° C. to about 30° C.

In an example, the first half cell 12 defines a first chamber 18 that at least partially houses a first electrode 20 and a first electrolyte solution 22 (also referred to as “the first electrolyte 22”) and the second half cell 14 defines a second chamber 24 that at least partially houses a second electrode 26 and a second electrolyte solution 28 (also referred to as “the second electrolyte 28”). Examples of solutions that can comprise the first electrolyte 22 and the second electrolyte 28 include, but are not limited to, one or more of: a solution of potassium hydroxide (KOH) in water, a solution of sodium hydroxide (NaOH) in water, and a solution of lithium hydroxide (LiOH) in water.

In an example, one or both of the electrodes 20, 26 can be positioned proximate to the separator 16, such as by being abutted against a corresponding face of the separator 16, e.g., with the first electrode 20 being positioned proximate to a first separator face and the second electrode 26 being positioned proximate to a second separator face that opposes the first separator face.

In an example, the first electrode 20 is the anode for the electrolyzer cell 10 and the second electrode 26 is the cathode for the electrolyzer cell 10. Therefore, for the remainder of the present disclosure, the first half cell 12 may also be referred to as “the anode half cell 12,” the first chamber 18 may also be referred to as “the anode chamber 18,” the first electrode 20 may also be referred to as “the anode 20,” the first electrolyte 22 may also be referred to as “the anode electrolyte 22” or “the anolyte 22,” the second half cell 14 may also be referred to as “the cathode half cell 14,” the second chamber 24 may also be referred to as “the cathode chamber 24,” the second electrode 26 may also be referred to as “the cathode 26,” and the second electrolyte 28 may also be referred to as “the cathode electrolyte 28” or “the catholyte 28.” In an example, each electrode 20, 26 can comprise a high surface area metal, such as a fine metal mesh. In an example, each electrode 20, 26 comprises a nickel mesh.

The electrodes 20, 26 are the locations of the cell 10 where electron transfer half reactions occur, e.g., by reacting with one or more components of the electrolyte solutions 22, 28 in the chambers 18, 24 to generate H₂ gas and/or O₂ gas. Each of the electrodes 20, 26 can be coated with one or more electrocatalysts to speed reaction toward H₂ gas and/or toward O₂ gas. In a typical example, one of both of the electrodes 20, 26 comprises a conductive substrate, such as a nickel substrate body, with an electrocatalyst coated onto one or more surfaces of the conductive substrate. One or more binders can be used to adhere an electrocatalyst onto the conductive substrate of one or both of the electrodes 20, 26. In most cases, the electrocatalyst lowers the activation energy for the electrochemical reaction so that the reaction can proceed without the electrocatalyst being consumed by the reaction. By lowering the activation energy, an electrocatalyst is able to facilitate specific reactions at the electrode so that the electrochemical device has a reduced energy demand. Examples of electrocatalyst materials include, but are not limited to, metals, metal alloys, metal-metalloid alloys, metal oxides, metal phosphides, and metal sulfides.

Each of the electrodes 20, 26 can be configured for a particular electrochemical half reaction, such as the half reactions for the overall water electrolysis process described below. For example, the first electrode 20 can be configured to perform a first electrochemical half reaction and the second electrode 26 can be configured to perform a second electrochemical half reaction. The actual half reactions that take place at each electrode 20, 26 can depend on the type of local environment that is present at each electrode 20, 26 during operation of the electrolyzer cell 10, and in particular on the alkalinity (e.g., pH) of the anolyte 22 at the anode 20 and of the catholyte 28 at the cathode 26. Half Reaction [1], below, is an example of a reaction that can take place at the anode 20 when the anolyte 22 is alkaline (e.g., with a pH>7):

4 OH^{-→O}₂+2 H₂O+4 e⁻ [1]

Half Reaction [1] is also referred to as the “Oxygen Evolution Reaction [1]” or “the OER [1].” The O₂ gas that is generated by the OER [1] can form oxygen bubbles 30 in the anolyte 22 within the anode chamber 18, as shown in FIG. 1.

In an example, the pH of the anolyte 22 at the location of the anode 20 (also referred to as “the first local pH” so as to distinguish it from the pH of the catholyte 28) is about 8 or more, for example about 9 or more, such as about 10 or more, for example about 11 or more, such as about 12 or more, for example about 13 or more, such as about 14 or more. In an example, the first local pH of the anolyte 22 is from about 9 to about 15, for example from about 9 to about 14, from about 9 to about 13, from about 9 to about 12, from about 9 to about 11, from about 9 to about 10, from about 10 to about 15, from about 10 to about 14, from about 10 to about 13, from about 10 to about 12, from about 10 to about 11, from about 11 to about 15, from about 11 to about 14, from about 11 to about 13, from about 11 to about 12, from about 12 to about 15, from about 12 to about 14, from about 12 to about 13, from about 13 to about 15, from about 13 to about 14,or from about 14 to about 15.

Half Reaction [2], below, is an example of a reaction that can take place at the cathode 26 when the catholyte 28 is alkaline (e.g., with a pH>7):

2 e⁻+2 H₂O→H₂+2 OH⁻ [2]

Half Reaction [2] is also referred to as the “Hydrogen Evolution Reaction [2]” or “the HER [2].” The H₂ gas that is generated by the HER [2] can form hydrogen bubbles 32 in the catholyte 28 within the cathode chamber 24, as shown in FIG. 1.

In an example, the pH of the catholyte 28 at the location of the cathode 26 (also referred to as “the second local pH” so as to distinguish it from the first local pH of the anolyte 22) is about 8 or more, for example about 9 or more, such as about 10 or more, for example about 11 or more, such as about 12 or more, for example about 13 or more. In an example, the second local pH of the catholyte 28 is from about 8 to about 14, for example from about 8 to about 13, from about 8 to about 12, from about 8 to about 11, from about 8 to about 10, from about 8 to about 9, from about 9 to about 14, from about 9 to about 13, from about 9 to about 12, from about 9 to about 11, from about 9 to about 10, from about 10 to about 14, from about 10 to about 13, from about 10 to about 12, from about 10 to about 11, from about 11 to about 14, from about 11 to about 13, from about 11 to about 12, from about 12 to about 14, from about 12 to about 13, or from about 13 to about 14.

In an example, the anode 20 is electrically connected to an external positive conductive lead 34 (also referred to as “the anode lead 34”) and the cathode 26 is electrically connected to an external negative conductive lead 36 (also referred to as “the cathode lead 36”). In an example, when the separator 16 is wet and is in electrolytic contact with the electrodes 20, 26, and an appropriate voltage is applied across the leads 34 and 36, Half Reactions [1] and [2] are activated. As noted above, in Half Reaction [1], OH⁻ ions are oxidized at the anode 20, which liberates O₂ gas (e.g., as the oxygen bubbles 30 in the anolyte 22) and forms additional H₂O molecules in the anolyte 22. In Half Reaction [2], H₂O is reduced at the cathode 26, which liberates H₂ gas (e.g., as the hydrogen bubbles 32 in the catholyte 28, respectively) and forms additional OH⁻ ions in the catholyte 28. In some examples, at least a portion of the OH⁻ ions pass through the separator 16 (e.g., if the separator 16 is an anion exchange membrane) so that they are available to be oxidized via Half Reaction [1] at the anode 20.

The electrolyzer cell 10 can be configured so that the electrolyte solutions 22, 28 flow through the chambers 18, 24 so that each electrolyte solution 22, 28 can pick up the bubbles of its corresponding gas and carry the produced gas out of the electrolyzer cell 10. For example, the anolyte 22 can flow into the anode half cell 12 through an anolyte inlet 38 and can exit the anode half cell 12 through an anolyte outlet 40. Similarly, the catholyte 28 can flow into the cathode half cell 14 through a catholyte inlet 42 and can exit the cathode half cell 14 through a catholyte outlet 44. In an example, the flow of the anolyte 22 through the anode chamber 18 picks up the produced O₂ gas as the oxygen bubbles 30 and exits the anode chamber 18 through the anolyte outlet 40 and the flow of the catholyte 28 through the cathode chamber 24 picks up the produced H₂ gas as the hydrogen bubbles 32 and exits the cathode chamber 24 through the catholyte outlet 44. One or both of the gases can be separated from the electrolyte solutions 22, 28 downstream of the electrolyzer cell 10 with one or more appropriate separators. In an example, the produced H₂ gas is dried and harvested into high pressure canisters or fed into further process elements. The produced O₂ gas can be allowed to simply vent into the atmosphere or can be stored for other uses. In an example, the electrolyte solutions 22, 28 are recycled back into the half cells 12, 14, as needed.

In an example, a typical voltage across the electrolyzer cell 10 (e.g., the voltage difference between the anode lead 34 and the cathode lead 36) is from about 1.5 volts (V) to about 3.0 V. In an example, an operating current density for the electrolyzer cell 10 is from about 0.1 A/cm² to about 3 A/cm². Each cell 10 has a size that is sufficiently large to produce a sizeable amount of H₂ gas when operating at these current densities. In an example, an active area of each cell 10 (e.g., a width multiplied by a height for a rectangular cell) is from about 0.25 square meters (m²) to about 15 m², such as from about 1 m² to about 5 m², for example from about 2 m² to about 4 m², such as from about 2.25 m² to about 3 m², such as from about 2.5 m² to about 2.9 m². In an example, the total volume of each cell (e.g., a width multiplied by a height multiplied by a depth) is from about 0.1 cubic meter (m³) to about 2 m³, such as from about 0.15 m³ to about 1.5 m³, for example from about 0.2 m³ to about 1 m³, such as from about 0.25 m³ to about 0.5 m³, for example from about 0.275 m³ to about 0.3 m³. In a non-limiting example, the total volume of the entire electrolyzer system (e.g., the combined volume of all the cells in all the stacks in the plant) is from about 1 m³ to about 25,000 m³, such as from about 5 m³ to about 2,500 m³, for example from about 10 m³ to about 100 m³, such as from about 25 m³ to about 75 m³, for example from about 30 m³ to about 50 m³.

### pH Differential

As noted above, maintaining a pH differential across the separator 16 can be beneficial to the overall operation of the electrolyzer cell 10. As used herein, the term “pH differential” refers to the difference between the first local pH of the anolyte 22 at the location of the anode 20 and the second local pH of the catholyte 28 at the location of the cathode 26.

In an example, the second local pH of the catholyte 28 is lower than the first local pH of the anolyte 22 so that there is a pH differential between the first local pH and the second local pH. The theoretical voltage for the entire water electrolysis reaction (i.e., the voltage required for the combination of the Oxygen Evolution Half Reaction [1] at the anode 20 and the Hydrogen Evolution Half Reaction [2] at the cathode 26) is known to be about 1.23 V when there is no pH differential between the electrolyte solutions 22, 28. However, when there is a pH differential such that the second local pH of the catholyte 28 is lower than the first local pH of the anolyte 22, then it has been found that the theoretical voltage required for the entire water electrolysis reaction is defined by Equation [3].

V_{Theoretical}=1.23−0.059×ΔpH [3]

where V_{Theoretical} is the theoretical voltage required to activate Half Reactions [1] and [2], and ΔpH is the difference between the first local pH of the anolyte 22 and the second local pH of the catholyte 28 (i.e., ΔpH=First Local pH−Second Local pH, wherein First Local pH≥Second Local pH). For example, if the first local pH of the anolyte 22 is 15 and the second local pH of the catholyte 28 is 11, then ΔpH=15−11=4, which results in the electrolyzer cell 10 having a theoretical water electrolysis potential, V_{Theoretical}, of 0.994 V, which is 0.236 V less than the 1.23 V theoretical potential for a cell with no pH differential. In other words, the voltage that is required to drive the water electrolysis Half Reactions [1] and [2] when the first local pH is 15 and the second local pH is 11 can be as much as about 19.2% lower than the voltage that is required when the first local pH and the second local pH are the same ((1.23−0.994)/1.23≈0.1919).

In an example, the first local pH of the anolyte 22 is about 8 or more, such as about 8.1 or more, about 8.2 or more, about 8.3 or more, about 8.4 or more, about 8.5 or more, about 8.6 or more, about 8.7 or more, about 8.8 or more, about 8.9 or more, about 9 or more, about 9.1 or more, about 9.2 or more, about 9.3 or more, about 9.4 or more, about 9.5 or more, about 9.6 or more, about 9.7 or more, about 9.8 or more, about 9.9 or more, about 10 or more, about 10.1 or more, about 10.2 or more, about 10.3 or more, about 10.4 or more, about 10.5 or more, about 10.6 or more, about 10.7 or more, about 10.8 or more, about 10.9 or more, about 11 or more, about 11.1 or more, about 11.2 or more, about 11.3 or more, about 11.4 or more, about 11.5 or more, about 11.6 or more, about 11.7 or more, about 11.8 or more, about 11.9 or more, about 12 or more, about 12.1 or more, about 12.2 or more, about 12.3 or more, about 12.4 or more, about 12.5 or more, about 12.6 or more, about 12.7 or more, about 12.8 or more, about 12.9 or more, about 13 or more, about 13.1 or more, about 13.2 or more, about 13.3 or more, about 13.4 or more, about 13.5 or more, about 13.6 or more, about 13.7 or more, about 13.8 or more, about 13.9 or more, about 14 or more, about 14.1 or more, about 14.2 or more, about 14.3 or more, about 14.4 or more, about 14.5 or more, about 14.6 or more, about 14.7 or more, about 14.8 or more, about 14.9 or more, about 15 or more, about 15.1 or more, about 15.2 or more, about 15.3 or more, about 15.4 or more, about 15.5 or more, about 15.6 or more, about 15.7 or more, about 15.8 or more, about 15.9. or about 16 or more. In an example, the first local pH of the anolyte 22 is from about 8 to about 16, such as from about 8.5 to about 16, from about 9 to about 16, from about 9.5 to about 16, from about 10 to about 16, from about 10.5 to about 16, from about 11 to about 16, from about 11.5 to about 16, from about 12 to about 16, from about 12.5 to about 16, from about 13 to about 16, from about 13.5 to about 16, from about 14 to about 16, from about 14.5 to about 16, from about 15 to about 16, or from about 15.5 to about 16.

In an example, the second local pH of the catholyte 28 is about 7 or more, such as about 7.1 or more, about 7.2 or more, about 7.3 or more, about 7.4 or more, about 7.5 or more, about 7.6 or more, about 7.7 or more, about 7.8 or more, about 7.9 or more, about 8 or more, about 8.1 or more, about 8.2 or more, about 8.3 or more, about 8.4 or more, about 8.5 or more, about 8.6 or more, about 8.7 or more, about 8.8 or more, about 8.9 or more, about 9 or more, about 9.1 or more, about 9.2 or more, about 9.3 or more, about 9.4 or more, about 9.5 or more, about 9.6 or more, about 9.7 or more, about 9.8 or more, about 9.9 or more, about 10 or more, about 10.1 or more, about 10.2 or more, about 10.3 or more, about 10.4 or more, about 10.5 or more, about 10.6 or more, about 10.7 or more, about 10.8 or more, about 10.9 or more, about 11 or more, about 11.1 or more, about 11.2 or more, about 11.3 or more, about 11.4 or more, about 11.5 or more, about 11.6 or more, about 11.7 or more, about 11.8 or more, about 11.9 or more, about 12 or more, about 12.1 or more, about 12.2 or more, about 12.3 or more, about 12.4 or more, about 12.5 or more, about 12.6 or more, about 12.7 or more, about 12.8 or more, about 12.9 or more, about 13 or more, about 13.1 or more, about 13.2 or more, about 13.3 or more, about 13.4 or more, about 13.5 or more, about 13.6 or more, about 13.7 or more, about 13.8 or more, about 13.9 or more, about 14 or more, about 14.1 or more, about 14.2 or more, about 14.3 or more, about 14.4 or more, about 14.5 or more, about 14.6 or more, about 14.7 or more, about 14.8 or more, about 14.9 or more, or about 15 or more. In an example, the second local pH of the catholyte 28 is from about 7 to about 15, such as from about 7.5 to about 15, from about 8 to about 15, from about 8.5 to about 15, from about 9 to about 15, from about 9.5 to about 15, from about 10 to about 15, from about 10.5 to about 15, from about 11 to about 15, from about 11.5 to about 15, from about 12 to about 15, from about 12.5 to about 15, from about 13 to about 15, from about 13.5 to about 15, from about 14 to about 15, or from about 14.5 to about 15.

In an example, the difference between the first local pH of the anolyte 22 and the second local pH of the catholyte 28 is 1 or more, such as 1.1 or more, 1.2 or more, 1.25 or more, 1.3 or more, 1.4 or more, 1.5 or more, 1.6 or more, 1.75 or more, 1.8 or more, 1.9 or more, 2 or more, 2.1 or more, 2.2 or more, 2.25 or more, 2.3 or more, 2.4 or more, 2.5 or more, 2.6 or more, 2.75 or more, 2.8 or more, 2.9 or more, 3 or more, 3.1 or more, 3.2 or more, 3.25 or more, 3.3 or more, 3.4 or more, 3.5 or more, 3.6 or more, 3.75 or more, 3.8 or more, 3.9 or more, 4 or more, 4.1 or more, 4.2 or more, 4.25 or more, 4.3 or more, 4.4 or more, 4.5 or more, 4.6 or more, 4.75 or more, 4.8 or more, 4.9 or more, 5 or more, 5.1 or more, 5.2 or more, 5.25 or more, 5.3 or more, 5.4 or more, 5.5 or more, 5.6 or more, 5.75 or more, 5.8 or more, 5.9 or more, 6 or more, 6.1 or more, 6.2 or more, 6.25 or more, 6.3 or more, 6.4 or more, 6.5 or more, 6.6 or more, 6.75 or more, 6.8 or more, 6.9 or more, such as about 7 or more. In an example, the pH differential between the first local pH of the anolyte 22 and the second local pH of the catholyte 28 is from about 1 to about 7, for example from about 1 to about 6, from about 1 to about 5, from about 1 to about 4, from about 1 to about 3, from about 1 to about 2, from about 2 to about 7, from about 2 to about 6, from about 2 to about 5, from about 2 to about 4, from about 2 to about 3, from about 3 to about 7, from about 3 to about 6, from about 3 to about 5, from about 3 to about 4, from about 4 to about 7, from about 4 to about 6, from about 4 to about 5, from about 5 to about 7, from about 5 to about 6, or from about 6 to about 7.

In an example, a balance between the electrical conductivity and the second local pH of the catholyte 28 is maintained such that the second local pH of the catholyte 28 is lower than the first local pH of the anolyte 22 and such that the catholyte 28 has an electrical conductivity that does not adversely affect the cell voltage owing to a large resistance across the electrolyzer cell 10. In an example, to achieve this goal, the catholyte 28 includes a salt comprising a polyatomic anion. The term “polyatomic anion,” used herein, includes a covalently bonded set of two or more atoms that has a non-zero net charge. Examples of polyatomic anion salts that can be added to the catholyte 28 include, but are not limited to, a carbonate, a citrate, an oxalate, ethylene diamine tetraacetic acid (EDTA), a malate, an acetate, a phosphate, a sulfate, or combinations thereof. In an example, the salt comprising polyatomic anion includes a cation, wherein the cation is selected from the group consisting of lithium, sodium, potassium, rubidium, cesium, or the like, and combinations thereof.

In an example, the aforementioned salt comprises cations and the polyatomic anion is selected such that the salt is stable and soluble in alkaline conditions (i.e., pH>7) and possesses one or more properties, such as, but not limited to, not blocking the transport mechanism of the separator 16, not migrating through the separator 16, not reacting at the cathode 26, and/or not reacting with OH⁻ ions, H₂ gas, or O₂ gas. In an example, the polyatomic anion is such that the anion is selectively rejected by the separator 16 (if the separator 16 is an anion exchange membrane) so that only or substantially only OH⁻ ions are transported across the separator 16 from the cathode chamber 24 to the anode chamber 18 to maintain a pH differential. In an example, the polyatomic anion may also be selected such that its anion is stable in a reducing environment so that water is reduced at the cathode 26 instead of the polyatomic anion. In an example, the corresponding cation in the salt comprising the polyatomic anion is selected such that the cation does not pass through the separator 16 from the cathode chamber 24 to the anode chamber 18 and is not reduced at the cathode 26.

In an example, a concentration of the salt comprising the polyatomic anion within the catholyte 28 is from about 0.1 M to about 3 M, for example from about 0.1 M to about 2.5 M, such as from about 0.1 M to about 2 M, for example from about 0.1 M to about 1.5 M, such as from about 0.1 M to about 1 M, for example from about 0.1 M to about 0.5 M, such as from about 0.5 M to about 3 M, for example from about 0.5 M to about 2.5 M, such as from about 0.5 M to about 2 M, for example from about 0.5 M to about 1.5 M, such as from about 0.5 M to about 1 M, for example from about 1 M to about 3 M, such as from about 1 M to about 2.5 M, for example from about 1 M to about 2 M, such as from about 1 M to about 1.5 M, for example from about 1.5 M to about 3 M, such as from about 1.5 M to about 2.5 M, for example from about 1.5 M to about 2 M, such as from about 2 M to about 3 M, for example from about 2 M to about 2.5 M.

When a pH differential exists across a separator or membrane, like the separator 16 in the electrolyzer cell 10, the pH differential will tend to equilibrate over time. For example, in the electrolyzer cell 10 of FIG. 1 when the anolyte 22 and the catholyte 28 are alkaline (e.g., with a pH>7), then the OER [1] occurs at the anode 20 and the HER [2] occurs at the cathode 26. In the OER [1], hydroxide ions (OH⁻) in the anolyte 22 are oxidized to form O₂ gas and water molecules (H₂O). As OH⁻ ions are consumed from the anolyte 22 by the OER [1], the concentration of OH⁻ ions in the anolyte 22 will drop. Unless the OH⁻ ions consumed from the anolyte 22 are replenished, the first local pH of the anolyte 22 will drop. In the HER [2], H₂O in the catholyte 28 is reduced to form H₂ gas and OH⁻ ions. As the OH⁻ ions are produced in the catholyte 28, the concentration of OH⁻ ions in the catholyte 28 will increase. Unless the OH⁻ ions added to the catholyte 28 are neutralized or reduced, the second local pH of the catholyte 28 will rise. The combination of the first local pH of the anolyte 22 dropping as O₂ gas is produced at the anode 20 and the second local pH of the catholyte 28 rising as H₂ gas is produced at the cathode 26 will tend to cause the higher first local pH and the lower second local pH to move toward each other. This effect can be alleviated somewhat if the separator 16 is configured so that OH⁻ ions generated by the HER [2] into the catholyte 28 can pass through the separator 16 (e.g., if the separator 16 is an anion exchange membrane or a nanoporous membrane through which the OH⁻ ions can pass), but usually the transfer of OH⁻ ions through the separator 16 is not sufficient to counteract the tendency for the pH differential to equilibrate over time.

Therefore, in order to maintain a desired pH differential between the anolyte 22 and the catholyte 28, it is often necessary to add additional energy to the system in some form to maintain the differential. One prior system of maintaining a pH differential included using an alkaline anolyte (e.g., a KOH solution) and a neutral catholyte (e.g., nominally pure water) at startup of an electrolyzer cell with a cation exchange membrane (CEM) that allowed K⁺ ions to be transported through the CEM. The hydrogen evolution reaction resulted in accumulation of KOH at the cathode over time. In order to prevent the catholyte pH from raising over time, water was added to the catholyte to “wash” the KOH, such as by adding water evaporated from the anolyte or another “wash solution” to the catholyte over time. The catholyte “washing” system comprising a CEM was described in Teschke, “Theory and operation of a steady-state pH differential water electrolysis cell,” J. Applied Electrochemistry, Vol. 12 (1982), pp. 219-23 (hereinafter “Teschke I”) and in Teschke et al., “Operation of a Steady-State pH-Differential Water Electrolysis Cell, Int. J. Hydrogen Energy, Vol. 7 (1982), pp. 933-37(hereinafter “Teschke II”) (collectively “the Teschke System”).

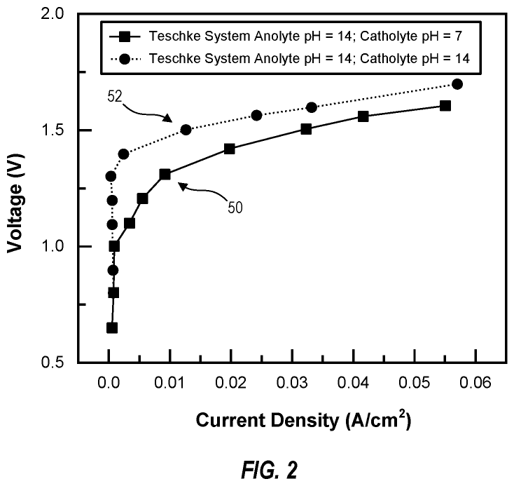

The Teschke System, and others like it, can provide for water electrolysis, but they typically do not perform at a high efficiency, often due to poor cell resistance. As used herein, the term “cell resistance” refers to the voltage required for a given current density. For example, FIG. 2 shows the voltage response for the Teschke System while operating at a pH differential of 7 (i.e., with the anolyte pH at 14 and the catholyte pH at 7—squares, data series 50) compared to the same system while operating with no pH differential (i.e., with both the anolyte and the catholyte at a pH of 14—circles, data series 52). As can be seen in FIG. 2, the Teschke System with a pH differential (data series 50) shows an improvement compared to the same system without a pH differential (data series 52), as indicated by the slight flattening of the curve for data series 50 versus data series 52, indicating a slightly lower cell resistance. However, the CEM in the Teschke System allows a large majority of its ionic current (e.g., around 99% or more) to be in the form of cations (K⁺ ions) moving from the anolyte to the catholyte. As used herein, the term “ionic current” refers to the “flow” of charge from one point in an electrolyzer cell to another point in the electrolyzer cell (often across an ion-exchange membrane or other separator), in order to distinguish that movement of charge from “electrical current,” which is the “flow” of charge via the transfer of electrons through a conductive material (such as the leads 34, 36 or the electrodes 20, 26 in the electrolyzer cell 10 of FIG. 1).

The large majority of the ionic current in the Teschke System being via the transfer of K⁺ ions through its CEM means that a large amount of OH⁻ ions will accumulate in the catholyte, and those OH⁻ ions must be rebalanced to maintain a pH differential long term. Moreover, even with the improved performance of the system with the pH differential (data series 50) compared to the system where both sides of the cell are operated at the same pH (data series 52), the Teschke system still exhibits a very high cell resistance and an undesirable curvature of the voltage-current density curve in the range of from about 0.02 A/cm² to about 0.05 A/cm².

### Electrochemical Cell

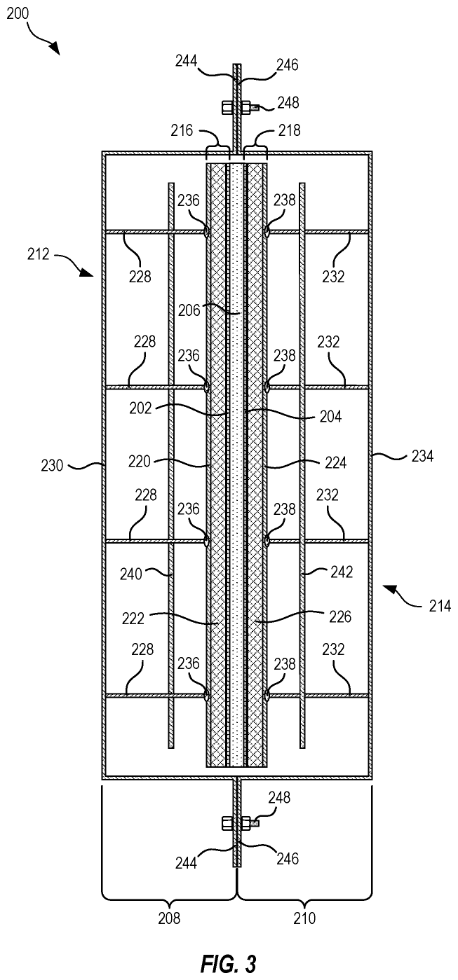

The present disclosure describes an electrolyzer cell that more efficiently takes advantage of a pH differential across a separator. FIG. 3 shows a cross-sectional view of an example electrolyzer cell 200 that includes one or more features of the present disclosure. The example electrolyzer cell 200 can operated at a pH differential more efficiently compared to prior art methods such as the Teschke System.

As shown in FIG. 3, the electrolyzer cell 200 includes a housing that at least partially encloses a cell interior, wherein a first electrode 202 and a second electrode 204, and in some examples a separator 206 are enclosed within the cell interior. In an example, each electrode 202, 204 can be part of a corresponding half cell. For example, the first electrode 202 can be included as part of a first half cell and the second electrode 204 can be included as part of a second half cell. In a non-limiting example, the first electrode 202 is the anode of the pan assembly 200 and the second electrode 204 is the cathode of the pan assembly 200, such that the electrodes 202, 204 will also be referred to as the anode 202 and the cathode 204, and the corresponding half cells will also be referred to as the anode half cell (i.e., the half cell associated with the anode 202) and the cathode half cell (i.e., the half cell associated with the cathode 204). There are also instances when the anode 202 and the cathode 204 are referred to more generically as “the electrode 202, 204” or “the electrodes 202, 204.”

One or both of the electrodes 202, 204 can be coated with an electrocatalyst material, such as particles of electrocatalyst that are coated or otherwise bound to one or more surfaces of an electrode substrate body to form one or both electrodes 202, 204. In an example, the electrocatalyst material (such as particles of electrocatalyst material) (if present on a particular electrode 202, 204) can be adhered to the substrate body of the electrode 202, 204 with a binder. Examples of substrate bodies include, but are not limited to, a fine mesh (such as a fine metal mesh, for example a fine nickel mesh), an expanded metal substrate, or a carbon paper substrate.

In an example, one or both of the electrodes 202, 204 comprises an ionomer, which has been found to improve overall cell resistance. The use of an ionomer was found to be particularly beneficial in the cathode 204 when the catholyte solution has a low conductivity, such as when the catholyte is pure water or is a low-concentration electrolyte (e.g., low concentration KOH) solution. In an example, the cathode comprises an electrode substrate coated with a catalyst coating. In an example, the catalyst coating comprises particles of electrocatalyst material that is bound to the electrode substrate with a binder comprising the ionomer. In an example, an ionomer materials can be used as part of one or both of the electrodes 202, 204 include, such as in a binder to bind electrocatalyst particles to the electrode substrate, include. Examples of ionomers that can be used for as a binder in one or both electrodes 202, 204, or incorporated into one or both electrodes 202, 204 in some other way, include but are not limited to, a fluoropolymer-based polymer with one or more ionic group modifications, such as ionic-modified polytetrafluoroethylene (PTFE). A commercial example of such an ionomer material that can be used as a binder include those sold under the NAFION™ trade name by The Chemours Co., Wilmington, DE, USA, which is a PTFE copolymer with perfluorovinyl ether and sulfonate groups modifying some of the tetrafluoroethylene base groups on the PTFE backbone.

The separator 206 can be situated between the anode half cell and the cathode half cell, for example by being positioned between the anode 202 and the cathode 204. As discussed above, the separator 206 can be configured to reduce migration of certain species between the electrodes 202, 204 while allowing one or more other species to pass from the anode half cell to the cathode half cell and/or from the cathode half cell to the anode half cell. The separator 206 can be similar or identical to the separator 16 described above for the electrolyzer cell 10 of FIG. 1. For example, the separator 206 can comprise a porous membrane (e.g., a microporous membrane or a nanoporous membrane), an ion-exchange membrane, or an ion solvating membrane. In examples wherein the separator 206 comprises an ion-exchange membrane, the membrane can be of different types, such as an anion exchange membrane (AEM), a cation exchange membrane (CEM), a proton exchange membrane (PEM), or a bipolar ion exchange membrane (BEM).

In a preferred example, the separator 206 is an anion exchange membrane that is configured to allow the passage of anions more freely, and in particular OH⁻ anions, as compared to the passage of cations, such as K⁺ cations. For example, the separator 206 can be an anion exchange membrane (AEM) that is configured specifically to allow the relatively free passage of OH⁻ anions (e.g., from the cathode side to the anode side of the separator 206) and that blocks or substantially blocks passage of K⁺ cations (e.g., to prevent or reduce the passage of K⁺ cations from the anode side to the cathode side of the separator 206). When the separator 206 is an AEM, it can allow OH⁻ ions on the cathode side of the separator 206 (e.g., OH⁻ ions that are present in the catholyte solution and/or OH⁻ ions that are produced by the Hydrogen Evolution Reaction [2]) to carry a substantial portion of the ionic current that flows across the separator 206, and in preferred examples a majority of the ionic current, for example at least about 90% of the ionic current, at least about 91%, at least about 91.5 %, at least about 92%, at least about 92.5%, at least about 93%, at least about 93.5%, at least about 94%, at least about 94.5%, at least about 95%, at least about 95.5%, at least about 96%, at least about 96.5%, at least about 97%, at least about 97.5%, at least about 98%, at least about 98.1%, at least about 98.2%, at least about 98.25%, at least about 98.3%, at least about 98.4%, at least about 98.5%, at least about 98.6%, at least about 98.7%, at least about 98.75%, at least about 98.8%, at least about 98.9%, at least about 99%, at least about 99.1%, at least about 99.2%, at least about 99.25%, at least about 99.3%, at least about 99.4%, at least about 99.5%, at least about 99.6%, at least about 99.7%, at least about 99.75%, at least about 99.8%, at least about 99.85%, at least about 99.9%, at least about 99.91%, at least about 99.92%, at least about 99.93%, at least about 99.94%, at least about 99.95%, at least about 99.96%, at least about 99.97%, at least about 99.98%, at least about 99.99% of the ionic current. Also, an AEM can transfer the produced OH⁻ ions to the anolyte where they are needed for the Oxygen Evolution Reaction [1]. Thus, an AEM can reduce the need for a material balance because a smaller amount of OH⁻ ions (or KOH) accumulates on the cathode side of the separator 206 awaiting rebalancing and return to the anolyte.

Non-limiting examples of membranes that can be used as the separator 206 in the electrolyzer cell 200 are the membranes sold under the FUMASEP™ trade name by Fumatech BWT GmbH, Bietigheim-Bissingen, Germany that can be used as an AEM in a water electrolyzer cell, such as the FUMASEP™ FAA-3-20 membrane, the FUMASEP™ FAA-2-20 membrane, the FUMASEP™ FAAM-20 membrane, and the FUMASEP™ FAAM-PK-75 membrane. Because an AEM is a preferred type of separator for use in the cell 200, the separator 206 will also be referred to as “the AEM 206” for the sake of brevity. However, even though the separator 206 will also be referred to as the AEM 206, those having skill in the art will appreciate that it may not be necessary for the separator 206 to be an AEM if the separator 206 is able to have transport properties that are useful for the electrolyzer cell 200. For example, rather than a strictly AEM material, the separator 206 can be made from a porous separator material that does not have ion exchange capacity, but that can still provide some material balance benefit and adequate cell resistance and durability, such as the separator material sold under the ZIRFON™ trade name by Agfa-Gevaert N.V., Mortsel, Belgium, such as the separator membrane sold under the ZIRFON™ PERL UTP 500 trade name.

In an example, each of the electrodes 202, 204 is situated in a “zero-gap” configuration relative to the separator 206. Although the term “zero-gap” would typically imply that one or both electrodes 202, 204 are in actual physical contact with the separator 206, in the present disclosure, the term “zero-gap” is expanded to mean that all structures between the two current collectors 220, 224 (described below) are in mechanical contact with no space for the liquid electrolyte to congregate. In other words, there could be one or more spacer materials inserted between one or both of the current collectors 220, 224 and the separator 206, and the overall structure would still be considered a “zero-gap architecture,” as that term is being used herein, so long as there is not a liquid electrolyte gap between the two current collectors 220, 224.

The housing of the cell 200 can comprise a pan assembly 208, 210 for one or both of the half cells, such as an anode-side pan assembly 208 for the anode half cell and a cathode-side pan assembly 210 for the cathode half cell (also referred to as the anode pan assembly 208 and the cathode pan assembly 210). In an example, each pan assembly 208, 210 includes a pan 212, 214 with an interior for receiving an electrolyte. For example, the anode pan assembly 208 can comprise an anode-side pan 212 for receiving an anolyte and the cathode pan assembly 210 comprising a cathode-side pan 214 for receiving a catholyte. The pan assemblies 208, 210 can be configured so that the electrolyte flowing through the pan 212, 214 will come into contact with its corresponding electrode 202, 204, e.g., so that H₂ gas can be evolved from the cathode 204 and, in some examples, so that O₂ gas can be evolved from the anode 202. Each pan assembly 208, 210 can also include an inlet for receiving electrolyte into the interior of the pan 212, 214, and one or more outlets so that electrolyte and evolved gas can exit the pan 212, 214 (not shown).

In an example, each electrode 202, 204 is electrically connected to its corresponding pan 212, 214 so that electrical current can flow from the pan 212, 214 to the electrode 202, 204 (as is the case for current flowing from an anode-side pan 212 to an anode 202) or from the electrode 202, 204 to the pan 212, 214 (as is the case for current flowing from a cathode 204 to a cathode-side pan 214). Each half cell can include one or more additional structures to provide for the electrical connection between the electrodes 202, 204 and the pans 212, 214. For example, one or both of the electrodes 202, 204 can be part of a corresponding electrode assembly comprising the electrode 202, 204 and one or more additional structures that enhance operation of the pan assembly 200. For example, the first electrode 202 (e.g., the anode 202) can be part of a first electrode assembly 216 (which will also be referred to herein as “the anode assembly 216”) and the second electrode 204 (e.g., the cathode 204) can be part of a second electrode assembly 218 (which will also be referred to herein as “the cathode assembly 218”).

In an example, one or both of the electrode assemblies 216, 218 include its corresponding electrode 202, 204, a current collector, and an optional elastic element (also sometimes referred to as a “mattress”). In an example, the anode assembly 216 includes the anode 202, an anode current collector 220 and an optional anode-side elastic element 222. Similarly, in an example, the cathode assembly 218 includes the cathode 204, a cathode current collector 224, and an optional cathode-side elastic element 226.

Each electrode assembly 216, 218 is coupled to its respective pan 212, 214, i.e., so that there is an electrical connection between the anode 202 and the anode-side pan 212 and between the cathode 204 and the cathode-side pan 214. In an example, one or both of the electrodes 202, 204 comprise a fine mesh structure, such as a fine woven mesh. A fine mesh, such as a woven mesh, have been found to make an excellent electrode for electrolyzer cells because it provides a high relative surface area, a relatively large open area for electrolyte and gas flow to and from the electrode, and are readily available in sizes that are large enough for a large commercial electrolyzer cell, e.g., with an active area of at least 1 m², such as from about 1 m² to about 4 m².

In an example, a differential fluid pressure can be applied across the separator 206 (e.g., with a pressure on the cathode side of the separator 206 being larger than on the anode side, or vice versa). The differential pressure, in addition to the elastic element 222, 226 can act to load the electrodes 202, 204 and create effective electrical contact across the active area of the electrodes 202, 204 without requiring welding to couple the electrodes 202, 204 to other structures in the pan assembly 200, particularly with fine mesh electrodes.

In an example, the woven mesh of one or both of the electrodes 202, 204 comprises a network of sets of crossing wires, which can be perpendicular or angled relative to one another, that alternative cross and bend over one another. For example, any particular wire alternates between passing under an adjacent cross wire and then over the next cross wire. In an example, one or both of the electrodes 202, 204 can comprise a woven wire mesh electrode formed from wires having a wire diameter of about 0.18 mm diameter with openings in the mesh of about 0.44 mm and with an open area of from about 50% to about 60%, such as from about 50% to about 55%. In an example, one or both of the electrodes 202, 204 is formed from an expanded mesh wherein one or both of the electrodes 202, 204 are fabricated from a sheet of material that is about 0.13 mm thick with a long way of the diamond shape (LWD) of about 2 mm and a short way of the diamond (SWD) of about 1 mm.

In an example, one or both of the anode 202 and the cathode 204 is made primarily or entirely from nickel. Fabricating both the anode 202 and the cathode 204 out of nickel enables the use of non-welded electrodes fabricated from fine woven meshes for both electrodes 202, 204, for example because nickel has a very low contact resistance. In an example, one or both of the anode 202 and the cathode 204 is coated with one or more catalyst materials, e.g., in the form of one or more catalyst coating layers on the electrode 202, 204. In an example, the one or more catalyst materials can be electrically conducting.

The current collector 220, 224 of each electrode assembly 216, 218 acts to distribute current flowing into or out of its respective electrode 202, 204. In an example, the current collector 220, 224 of each electrode assembly 216, 218 comprises a rigid structure, such as a rigid metal plate or mesh, which is electrically connected to its corresponding electrode 202, 204, either directly or indirectly. In an example, each current collector 220, 224 can comprises an expanded metal sheet, such as an expanded nickel sheet.

In an example, each elastic element 222, 226 comprises a compressible and expandable structure that provides a controlled load when compressed. For example, the elastic element 222, 226 can be compressed between the separator 206 and the current collector 220, 224, and the resulting load that results as the elastic element 222, 226 tries to expand back to its fully expanded position acts to load the electrode 202, 204 against the separator 206 to provide a zero-gap configuration between the electrode 202, 204 and the separator 206. In an example, the elastic element 222, 226 is also electrically conductive (e.g., the elastic element 222, 226 is made from or is coated with an electrically conductive material, such as nickel) so that it will conduct electricity from the current collector 220, 224 to the electrode 202, 204 or vice versa. In an example, each of the one or more elastic elements 222, 226 comprise one or more electrically conductive filaments that are woven together into an elastic layer that can expand and collapse to apply the controlled load when the elastic layer is compressed. In some examples, one or both of the elastic elements 222, 226 can be a corrugated knitted mesh having a pre-load of about 2 pounds per square inch at about 3 mm of compression. In an example, an uncompressed thickness of one or both of the elastic elements 222, 226 can be from about 5 mm to about 7 mm. One or both of the elastic elements 222, 226 can have a corrugation pitch of about 10 mm. In an example, one or both of the elastic elements 222, 226 are formed from wire having a wire diameter of about 0.15 mm.

In the example shown in FIG. 3 both the anode assembly 216 and the cathode assembly 218 include an elastic element 222, 226, e.g., such that the anode-side elastic element 222 provides a first loading force to compress the anode 202 against one side of the separator 206 and the cathode-side elastic element 226 provides a second loading force to compress the cathode 204 against an opposing side of the separator 206. In other examples (not shown in the Figures), there is an elastic element on only one side of the separator 206 (e.g., with only the anode assembly 216 having the elastic element 228 and with the cathode assembly 218 omitting the elastic element 232, or vice versa with only the cathode assembly 218 having the elastic element 232 and with the anode assembly 216 omitting the elastic element 228). In such a configuration, the elastic element on only one side of the separator 206 can produce sufficient compressive load so that both electrodes 202, 204 are compressed against the opposing sides of the separator 206.

In an example, the current collectors 220, 224 can be coupled to their respective pans 212, 214, e.g., so that the current collector 220, 224 is electrically connected to its corresponding pan 212, 214, which provides part of the electrical path between the electrode 202, 204 and the pan 212, 214. In order to accommodate this electrical connection between the current collector 220, 224 and its corresponding pan 212, 214, in an example, each pan assembly 208, 210 includes one or more ribs that extend between the electrode assembly 216, 218 and a back wall of the pan. For example, the anode pan assembly 208 can include one or more ribs 228 that extend between a back wall 230 of the anode-side pan 212 and the anode assembly 216, while the cathode pan assembly 210 can include one or more ribs 232 that extend between a back wall 234 of the cathode-side pan 214 and the cathode assembly 218. The one or more ribs 228 can be welded to the back wall 230 of the anode-side pan 212 while the one or more ribs 232 can be welded to the back wall 234 of the cathode-side pan 214.

In an example, one or more, and in some examples all, of the structures described so far for the electrolyzer cell 200 of FIG. 3 are planar or substantially planar and can be aligned to be parallel or substantially parallel to each other, as shown in FIG. 3. For example, one or any combination of the following, including all of the following, can be planar or substantially planar, and one or any combination of the following, including all of the following, can be aligned to be parallel or substantially parallel to each other, including: a main (e.g., largest) face of the anode-side pan 212 (such as the back wall 230 of the anode-side pan 212); the anode current collector 220; the anode-side elastic element 222, the anode 202, the cathode 204, the cathode-side elastic element 226; the cathode current collector 224; and a main (e.g., largest) face of the cathode-side pan 214 (such as the back wall 234 of the cathode-side pan 214). In an example, one or more, and in some examples all, of those same structures can be rectangular or substantially rectangular is cross-sectional shape.

The one or more ribs 228, 232 of each pan assembly 208, 210 can be electrically coupled to its corresponding electrode assembly 216, 218 by one or more welds, e.g., one or more welds 236 that electrically couple the anode assembly 216 to the one or more ribs 228 of the anode pan assembly 208 and one or more welds 238 that electrically couple the cathode assembly 218 to the one or more ribs 232 of the cathode pan assembly 210. As shown in FIG. 3, in an example, the one or more welds 236 can electrically couple the one or more ribs 228 to the anode current collector 220 and the one or more welds 238 can electrically couple the one or more ribs 232 to the cathode current collector 224.

In an example, the electrodes 202, 204 can be electrically connected to the one or more ribs 228, 232 and the one or more welds 236, 238. In examples where the electrode assembly 216, 218 includes the current collector 220, 224 that is welded to the one or more ribs 228, 232, then the electrode 202, 204 of the electrode assembly 216, 218 can be electrically coupled to the current collector 220, 224 via physical contact between the electrode 202, 204 and the current collector 220, 224, e.g., such as by wrapping the flexible electrode 202, 204 around a back side of the current collector 220, 224 so that there is physical contact between the mesh electrode 202, 204 and the current collector 220, 224, and/or through the elastic element 222, 226, which can also be made from a conductive material, such as metal. In an example, each of the mesh electrode 202, 204, the current collector 220, 224, and the elastic element 222, 226 of each electrode assembly 216, 218 can be made from nickel. When the loading pressure across an interface is sufficiently high (e.g., the loading pressure provided by one or both of the elastic element 222, 226 and a differential pressure across the cell), the contact resistance of a contact point between a nickel surface another electrically conductive material is very low, such that when a nickel electrode 202, 204 is in contact with a nickel elastic element 222, 226 or a nickel current collector 220, 224, electricity will readily flow through the contact point between the two nickel structures. This can allow the electrodes 202, 204 to be coupled to the electrode assembly 216, 218 without requiring welding between the electrodes 202, 204 and another structure while still providing for low resistance between the electrodes 202, 204 and the rest of the pan assembly 200.

The electrodes 202, 204 can be electrically coupled to the supplied electrical current via the one or more ribs 228, 232 and the one or more welds 236, 238. During operation of the pan assembly 200, current flows from a conductor contacting the anode-side pan 212 (similar to the anode conductor 116 in the electrolyzer cell 100 of FIG. 1), where the current can then flow to the one or more ribs 228 of the anode pan assembly 208 (e.g., through welds between the ribs 228 and the back wall 230), then to the anode current collector 220 via the one or more welds 236, and then into the anode 202 (e.g., via the contact between the anode current collector 220 and the anode 202 or via the electrically-conducting anode-side elastic element 222). The current can then pass between the anode 202 and the cathode 204 via the separator 206. The current then flows from the cathode 204 to the cathode current collector 224 (e.g., via the contact between the cathode 204 and the cathode current collector 224 or via the electrically conducting cathode-side elastic element 226), where it can then flow from the cathode current collector 224 to the one or more ribs 232 via the one or more welds 238. Then, the current can flow from the one or more ribs 232 to the cathode-side pan 214 (such as via welds between the one or more ribs 232 and the back wall 234 of the cathode-side pan 214), and finally out of the pan assembly 200 via a conductor that is contacting the cathode-side pan 214 (similar to the cathode conductor 126 in the electrolyzer cell 100 of FIG. 1).

The geometry and spacing of the one or more ribs 228, 232 can dictate current flow through the pan assemblies 208, 210. The geometry of the ribs 228, 232 can include, but is not limited to, the number of the ribs 228, 232, the height of the ribs 228, 232 (e.g., the distance between the back wall 230, 234 and the electrode assembly 216, 218 to which the ribs 228, 232 are connected), the physical design of the ribs 228, 232, the pitch between adjacent ribs 228, 232, and/or the thickness of the ribs 228, 232. As the current flows in through the ribs 228, 232 and the welds 236, 238, the geometry, spacing or density, and/or cross-sectional area of the welds 236, 238 can also impact current flow through the pan assemblies 208, 210. For example, as increasingly high currents flow through the cell, the density and the cross sectional area of the welds 236, 238 can impact local Joule heating and the formation of local hot spots, which can cause damage to the separator 206. In an example, the geometry, spacing, and cross-sectional area of the ribs 228, 232 and/or the welds 236, 238 can facilitate efficient operation of the pan assembly 200 at high current densities.

In an example, one or both of the pan assemblies 208, 210 includes a baffle plate that is fitted within its corresponding pan 212, 214 that is generally aligned with the orientation of the pan 212, 214 and the electrode assembly 216, 218 of that particular pan assembly 208, 210. For example, the anode pan assembly 208 can include an anode-side baffle plate 240 located within the interior of the anode-side pan 212 and the cathode pan assembly 210 can include a cathode-side baffle plate 242 located within the interior of the cathode-side pan 214. Each baffle plate 240, 242 is coupled to its corresponding set of one or more ribs 228, 232 to position the baffle plate 240, 242 within its corresponding pan 212, 214, e.g., at a specified position relative to its corresponding electrode assembly 216, 218 and/or its corresponding back wall 230, 234.

In an example, one or both of the baffle plates 240, 242 comprise a solid plate that is configured to fit over or within the one or more ribs 228, 232 of its corresponding pan assembly 208, 210. In other examples, one or both of the baffle plates 240, 242 can comprise an expanded metal plate or a mesh. In an example, one or both of the baffle plates 240, 242 are made from a conductive metal, such as, but not limited to, nickel, stainless steel, and the like. In another example, one or both of the baffle plates 240, 242 are made from a polymeric material.

As will be appreciated by those having skill in the art, the contribution of internal power dissipation to the internal temperature distribution within the pan assembly 200 can be reduced or minimized through operating conditions such as the temperature and flow rate of the electrolyte flowing through the pan assembly 200 (e.g., through the pan assemblies 208, 210). High electrolyte flow rates can increase and in some examples maximize convective heat transfer within the pan assembly 200, thereby helping to reduce or minimize heat buildup and the corresponding concomitant temperature rise within the cell 200 that could otherwise result from high current densities. The baffle plates 240, 242 can provide for mixing of electrolyte as it flows through the pan assemblies 208, 210 to enhance convective heat transfer within the electrolyte during electrolysis.

In some examples, the baffle plate 240, 242 is designed and positioned in its corresponding pan 212, 214 in such a way that the gas produced at the electrode assembly 216, 218 can mix with the electrolyte on the side of the baffle plate 240, 242 closest to the electrode assembly 216, 218, resulting in a relatively low density column and defining a riser section. The low density mixture can rise relatively quickly through the riser section. Once above the top of the baffle plate 240, 242, the gas can disengage and flow into an outlet (such as a manifold, not shown in FIG. 3). A fraction of the electrolyte may then drop back down the side of the baffle plate 240, 242 closer to the back wall 230, 234 of the pan 212, 214 (i.e., the side opposite to the electrode assembly 216, 218) into a down-comer region, thereby creating a circulation loop.

The gas evolved at the electrode 202, 204 impacts the flow of the electrolyte, dragging some of the electrolyte up, and buffeting some of the electrolyte laterally. Gas lift occurs along the region adjacent to the electrode assembly 216, 218. The presence of the baffle plate 240, 242 can create a strong circulation within the pan assembly 208, 210. The flow of electrolyte in the riser section on the side of the baffle plate 240, 242 closest to the electrode assembly 216, 218 can be strongly oriented upward due to gas lift, and the flow in the down-comer section on the side of the baffle plate 240, 242 closest to the back wall 230, 234 can be strongly oriented downward. The relatively high velocities and shear rates in the riser section can help sweep gas from the electrode assembly 216, 218, provide efficient top to bottom mixing within the pan 212, 214, and drive increased convective cooling.

The baffle plate 240, 242 can be used to create a rapidly flowing circulation loop so that the electrolyte remains substantially isothermal as it flows through the pan assemblies 208, 210. Due to the high degree of top-bottom mixing and circulation, rapid thermal equilibration of the electrolyte can be achieved as it flows into and through the pan assemblies 208, 210. Another advantage is that relatively cold electrolyte can be introduced into the pan assembly 208, 210 which can equilibrate with warm circulating electrolyte fluid relatively quickly. The circulation rate (or laps of the recirculation loop during electrolyte transit through the pan 212, 214) can be anywhere from 1 to 200. The high circulation rate can also drive larger shear rates adjacent to the separator 206, helping to sweep gas away from the separator 206 and/or enhance or maximize heat transfer from the separator 206 to the electrode 202, 204.

The pan assemblies 208, 210 can be coupled together to enclose the interior of the pan assembly 200. For example, a flange 244 of the anode-side pan 212 can be coupled to a corresponding flange 246 of the cathode-side pan 214, such as with one or more fasteners 248. In the example shown in FIG. 3, the one or more fasteners 248 include one or more bolts and corresponding nuts that can be used to securely affix the flanges 244 and 246 together to enclose the interior of the pans 212, 214 and form the overall pan assembly 200.

Additional details regarding various components or substructures that can be used in electrolyzer cells according to the present disclosure are described in U.S. Pat. No. 11,390,956, issued on Jul. 19, 2022, entitled “ANODE AND/OR CATHODE PAN ASSEMBLIES IN AN ELECTROCHEMICAL CELL, AND METHODS OF USE AND MANUFACTURE THEREOF;” in U.S. Pa. No. 11,431,012, issued on Aug. 30, 2022, entitled “ELECTROCHEMICAL CELL WITH GAP BETWEEN ELECTRODE AND MEMBRANE, AND METHODS TO USE AND MANUFACTURE THEREOF;” in U.S. Pat. No. 11,444,304, issued on Sep. 13, 2022, entitled “ANODE AND/OR CATHODE PAN ASSEMBLIES IN AN ELECTROCHEMICAL CELL, AND METHODS TO USE AND MANUFACTURE THEREOF;” in U.S. patent application Ser. No. 17/936,322, filed on Sep. 28, 2022, entitled “SYSTEMS AND METHODS TO MAKE HYDROGEN GAS WITH A STEADY-STATE PH DIFFERENTIAL;” in U.S. patent application Ser. No. 18/162,290, filed on Jan. 31, 2023, entitled “FLATTENED WIRE MESH ELECTRODE FOR USE IN AN ELECTROLYZER CELL;” in U.S. patent application Ser. No. 18/163,010, filed on Feb. 1, 2023, entitled “ELECTROLYZER CELL AND METHODS OF USING AND MANUFACTURING THE SAME;” and in U.S. patent application Ser. No. 18/166,340, filed on Feb. 8, 2023, entitled “NANOPOROUS MEMBRANE SUPPORT IN AN ELECTROLYZER CELL;” the disclosures of all of which are incorporated herein by reference in their entireties.

### EXAMPLES

Various embodiments of the present invention can be better understood by reference to the following EXAMPLES which are offered by way of illustration. The present invention is not limited to the EXAMPLES given herein.

### Example 1

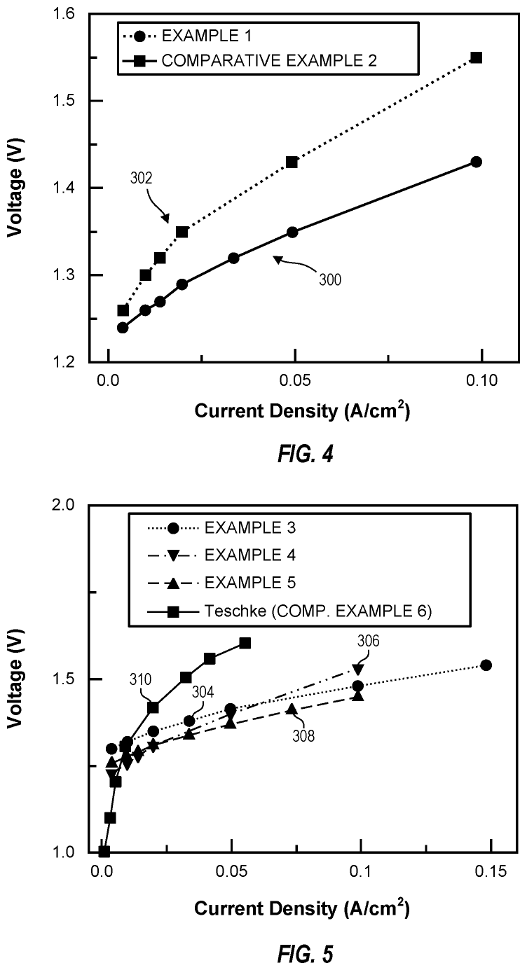

An electrolyzer cell having a substantially similar structure to that shown in FIG. 3 was assembled. The anode (e.g., anode 202) comprised a fine woven mesh nickel electrode. The cathode (e.g., cathode 204) comprised a carbon paper substrate coated with a catalyst coating comprising platinum catalyst particles bound to the carbon paper substrate with NAFION binder. The separator (e.g., separator 206) was an anion-exchange membrane (AEM) sold under the trade name FUMASEP™ FAA-2-20 by Fumatech BWT GmbH, Bietigheim-Bissingen, Germany. The anode electrolyte solution comprised a KOH solution (pH from about 12 to about 14), and the cathode electrolyte solution was deionized (DI) water (pH of about 7). The cell was operated at a temperature of 71° C. at various current densities between about 0.01 amps per square centimeter (A/cm²) and about 0.1 A/cm². The voltage required to operate at the various current densities is included in FIG. 4 as data series 300.

### Comparative Example 2

In order to test the effect of the cathode comprising the ionomer with a conventional electrolysis wherein both electrodes comprise a metal substrate, an electrolysis cell similar to the cell of EXAMPLE 1 was assembled, with the only difference being that the cathode in the cell of COMPARATIVE EXAMPLE 2 comprises a fine nickel mesh coated with a ruthenium catalyst without the use of an ionomer instead of the carbon paper substrate coated with catalyst using an ionomer binder as in EXAMPLE 1. The same KOH solution and DI water as in EXAMPLE 1 were used as the anode electrolyte and the cathode electrolyte, respectively. The cell of COMPARATIVE EXAMPLE 2 was operated at the same 71° C. and at the same current densities as the cell of EXAMPLE 1. The voltages required to operate the cell at these current densities is included in FIG. 4 as data series 302.

As can be seen in FIG. 4, when the cathode comprises an ionomer, the voltage required is reduced compared to an almost identical electrolysis cell without the ionomer containing cathode.

### Examples 3-5

The electrolysis cell of EXAMPLE 1 was used for each of EXAMPLE 3, EXAMPLE 4, and EXAMPLE 5, i.e., with a cathode comprising a carbon paper substrate coated with platinum catalyst and an ionomer binder. For EXAMPLE 3, the anode electrolyte solution comprised 9.9 M KOH (with a calculated pH of about 14.95) and the cathode electrolyte solution comprised 0.33 M KOH (pH of from about 9 to about 10). For EXAMPLE 4, the anode electrolyte solution comprised the same 9.9 M KOH solution as in EXAMPLE 3 and the cathode electrolyte comprised deionized water (pH of about 7). For EXAMPLE 5, the anode electrolyte solution comprised 6.9 M KOH (calculated pH of about 14.26) and the cathode electrolyte solution comprised deionized water. The cell was operated at a temperature of 70° C. at various current densities between about 0.01 A/cm² and about 0.15 A/cm². The voltage required to operate at the various current densities is included in FIG. 5 as data series 304 (EXAMPLE 3), data series 306 (EXAMPLE 4), and data series 308 (EXAMPLE 5).

### Comparative Example 6

Data for the prior art Teschke System from Teschke I and Teschke II (described above) with an anode electrolyte at a pH of 14 and a cathode electrolyte at a pH of 7, which is also included in FIG. 5 as data series 310.

As can be seen in FIG. 5, voltages for a particular current density are lower for the cells of the present disclosure (FIGS. 3-5) were lower for all but the very lowest current densities. Also, there appears to be much less upward curvature at current densities above about 0.05 A/cm2 compared to the voltage required for the Teschke system.

The present invention is depicted with strong electrolyte as anolyte and dilute electrolyte or even pure water as catholyte. One may also retain some of the benefit of a pH differential and still use strong electrolytes on both sides that differ from each other. For example, it may be beneficial to operate with 9.9 M KOH as anolyte and 1.4 M KOH as catholyte. In such a case, a pH differential of about 2.1 pH units is expected at 70° C.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An electrochemical cell comprising:
an anode;
an anode electrolyte solution in contact with the anode, wherein the anode electrolyte solution has a first pH;
a cathode comprising an ionomer;
a cathode electrolyte solution in contact with the cathode wherein the cathode electrolyte solution has a second pH; and
a separator positioned between the anode and the cathode;
wherein the electrochemical cell is configured to maintain a pH differential between the first pH and the second pH.

2. The electrochemical cell of claim 1, wherein the cathode comprises a substrate coated with a catalyst coating, wherein the catalyst coating comprises the ionomer.

3. The electrochemical cell of claim 2, wherein the catalyst coating comprises particles of catalyst material and a binder that binds the particles of catalyst material to the substrate, wherein the binder comprises the ionomer.

4. The electrochemical cell of claim 1, wherein the ionomer comprises a fluoropolymer-based polymer with one or more ionic group modifications.

5. The electrochemical cell of claim 4, wherein the ionomer comprises a polytetrafluoroethylene backbone modified with one or more ionic groups.

6. The electrochemical cell of claim 5, wherein the one or more ionic groups comprise one or more perfluorovinyl ether groups and one or more sulfonate groups.

7. The electrochemical cell of claim 1, wherein the ionomer comprises NAFION.

8. The electrochemical cell of claim 1, wherein the pH differential is a steady-state pH differential between the first pH and the second pH.

9. The electrochemical cell of claim 1, wherein the first pH is higher than the second pH.

10. The electrochemical cell of claim 1, wherein the first pH of the anode electrolyte solution is from about 14 to about 16.

11. The electrochemical cell of claim 1, wherein the second pH of the cathode electrolyte solution is from about 7 to about 15.

12. The electrochemical cell of claim 1, wherein an absolute value of the pH differential is from about 1 to about 10.

13. The electrochemical cell of claim 1, wherein an absolute value of the pH differential is from about 1 to about 4.

14. The electrochemical cell of claim 1, wherein the separator comprises at least one of: an anion exchange membrane, a porous separator, and an ion solvating separator.

15. A method of electrolysis, the method comprising:
providing an electrochemical cell comprising a separator having a first side and an opposing second side, am anode positioned on the first side of the separator, and a cathode comprising an ionomer positioned on the second side of the separator;
contacting the anode with an anode electrolyte solution having a first pH;
contacting the cathode with a cathode electrolyte solution having a second pH;
maintaining a pH differential between the first pH and the second pH;
passing current between the anode and the cathode; and
producing hydrogen gas (H₂) at the cathode.

16. The method of claim 15, wherein the cathode comprises a substrate coated with a catalyst coating, wherein the catalyst coating comprises the ionomer.

17. The method of claim 16, wherein the catalyst coating comprises particles of catalyst material and a binder that binds the particles of catalyst material to the substrate, wherein the binder comprises the ionomer.

18. The method of claim 15, wherein the ionomer comprises a fluoropolymer-based polymer with one or more ionic group modifications.

19. The method of claim 18, wherein the ionomer comprises a polytetrafluoroethylene backbone modified with one or more ionic groups.

20. The method of claim 19, wherein the one or more ionic groups comprise one or more perfluorovinyl ether groups and one or more sulfonate groups.

21. The method of claim 15, wherein the ionomer comprises NAFION.

22. The method of claim 15, wherein maintaining the pH differential comprises maintaining a steady-state pH differential between the first pH and the second pH.

23. The method of claim 15, wherein the first pH of the anode electrolyte solution is from about 8 to about 16.

24. The method of claim 15, wherein the second pH of the cathode electrolyte solution is from about 7 to about 15.

25. The method of claim 15, wherein an absolute value of the pH differential is from about 1 to about 4.
